(19) United States
(12) Patent Application Publication
(10) Pub. No.: US 2021/0253455 A1
(43) Pub. Date: Aug. 19, 2021

(54) DEVICES AND METHODS FOR WATER TREATMENT

(71) Applicant: SHANGHAI TETRELS MATERIAL TECHNOLOGY CO., LTD., Shanghai (CN)

(72) Inventors: Kunzhou LI, Seoul (KR); Byeongho LEE, Changwon-si (KR); Zisong NIE, Princeton, NJ (US)

(21) Appl. No.: 17/259,413

(22) PCT Filed: Jul. 10, 2019
(86) PCT No.: PCT/US2019/041204

§ 371 Date: Jan. 11, 2021

Related U.S. Application Data
(60) Provisional application No. 62/696,636, filed on Jul. 11, 2018.

(51) Int. Cl. C02F 1/58; C02F 1/44; B01D 69/10; B01D 69/12

(52) U.S. Cl. CPC C02F 1/58; C02F 1/442; C02F 2101/203; B01D 69/12; B01D 69/10

(57) ABSTRACT

A water-permeable device. The device has a supporting layer and a water-permeable membrane. The water-permeable membrane includes graphene layers that are aligned to form interlayer hydrophobic channels between the graphene layers. The interlayer hydrophobic channels are positioned to be aligned with the direction of water permeation. Also disclosed are systems and methods for water treatment.

### TECHNICAL FIELD

The present disclosure relates generally to devices and systems for water treatment and, more particularly, to graphite structures or graphene three-dimensional array structures and related water-filtration membranes, devices, and manufacturing processes.

### BACKGROUND OF THE INVENTION

Desalination has received attention as an important technology because water scarcity is one of the most serious global challenges for humanity. Conventionally, desalination can be done by evaporation (or thermal distillation) or reverse osmosis (RO). However, both technologies require high energy consumption for operation. For example, RO, which uses a semipermeable membrane to remove molecules and ions from drinking water, uses an applied pressure to overcome osmotic pressure. A typical RO plant consumes 1.5 to 2.5 kilowatt-hours (kWh) of electricity to produce 1 m³ of freshwater from seawater. In a thermal distillation, the energy consumption goes up to 10 times that amount. Conventional semi-permeable membranes, which can effectively remove impurities such as ions, often suffer from poor water permeability. Development of high water-permeable membranes is needed for fresh water treatment.

### SUMMARY OF THE INVENTION

Disclosed are devices and systems for water treatment. In one aspect, disclosed is a water-permeable device comprising: a supporting layer; and a water-permeable membrane, comprising graphene layers that are aligned to form interlayer hydrophobic channels between the graphene layers, wherein the interlayer hydrophobic channels are positioned to be aligned with the direction of water permeation.

In some cases, the graphene layers have an average angular spread of at least about 0.1°, about 0.5°, about 1°, about 2°, about 5°, about 10°, about 15°, or about 20°. In some cases, the graphene layers have an average angular spread of at most about 0.1°, about 0.5°, about 1°, about 2°, about 5°, about 10°, about 15°, or about 20°. In some cases, the graphene layers have an average angular spread of about 0.1° to about 20°. In some cases, the graphene layers have an average angular spread of about 0.1° to about 0.5°, about 0.1° to about 1°, about 0.1° to about 2°, about 0.1° to about 5°, about 0.1° to about 10°, about 0.1° to about 15°, about 0.1° to about 20°, about 0.5° to about 1°, about 0.5° to about 2°, about 0.5° to about 5°, about 0.5° to about 10°, about 0.5° to about 15°, about 0.5° to about 20°, about 1° to about 2°, about 1° to about 5°, about 1° to about 10°, about 1° to about 15°, about 1° to about 20°, about 2° to about 5°, about 2° to about 10°, about 2° to about 15°, about 2° to about 20°, about 5° to about 10°, about 5° to about 15°, about 5° to about 20°, about 10° to about 15°, about 10° to about 20°, or about 15° to about 20°. In some cases, the graphene layers have an average angular spread of about 0.1°, about 0.5°, about 1°, about 2°, about 5°, about 10°, about 15°, or about 20°. In some cases, the graphene layers have an average angular spread of less than 10°. In some cases, the graphene layers have an average angular spread of less than 1°.

In some cases, the graphene layers have an average size of at least about 0.1 μm, about 0.2 μm, about 0.5 μm, about 1 μm, about 2 μm, about 5 μm, about 10 μm, or about 20 μm. In some cases, the graphene layers have an average size of at most about 0.1 μm, about 0.2 μm, about 0.5 μm, about 1 μm, about 2 μm, about 5 μm, about 10 μm, or about 20 μm. In some cases, the graphene layers have an average size of about 0.1 μm to about 20 μm. In some cases, the graphene layers have an average size of about 0.1 μm to about 0.2 μm, about 0.1 μm to about 0.5 μm, about 0.1 μm to about 1 μm, about 0.1 μm to about 2 μm, about 0.1 μm to about 5 μm, about 0.1 μm to about 10 μm, about 0.1 μm to about 20 μm, about 0.2 μm to about 0.5 μm, about 0.2 μm to about 1 μm, about 0.2 μm to about 2 μm, about 0.2 μm to about 5 μm, about 0.2 μm to about 10 μm, about 0.2 μm to about 20 μm, about 0.5 μm to about 1 μm, about 0.5 μm to about 2 μm, about 0.5 μm to about 5 μm, about 0.5 μm to about 10 μm, about 0.5 μm to about 20 μm, about 1 μm to about 2 μm, about 1 μm to about 5 μm, about 1 μm to about 10 μm, about 1 μm to about 20 μm, about 2 μm to about 5 μm, about 2 μm to about 10 μm, about 2 μm to about 20 μm, about 5 μm to about 10 μm, about 5 μm to about 20 μm, or about 10 μm to about 20 μm. In some cases, the graphene layers have an average size of about 0.1 μm, about 0.2 μm, about 0.5 μm, about 1 μm, about 2 μm, about 5 μm, about 10 μm, or about 20 μm. In some cases, the graphene layers have an average size of less than 20 μm. In some cases, the graphene layers have an average size of less than 5 μm. In some cases, the graphene layers have an average size of about 1 μm.

In some cases, the interlayer hydrophobic channels have an average thickness of at least about 1 Å, about 2 Å, about 3 Å, about 3.5 Å, about 4 Å, about 5 Å, about 6 Å, about 7 Å, about 8 Å, about 9 Å, about 10 Å, or about 20 A. In some cases, the interlayer hydrophobic channels have an average thickness of at most about 1 Å, about 2 Å, about 3 Å, about 3.5 Å, about 4 Å, about 5 Å, about 6 Å, about 7 Å, about 8 Å, about 9 Å, about 10 Å, or about 20 Å. In some cases, the interlayer hydrophobic channels have an average thickness of about 1 Å to about 20 Å. In some cases, the interlayer hydrophobic channels have an average thickness of about 1 Å to about 2 Å, about 1 Å to about 3 Å, about 1 Å to about 3.5 Å, about 1 Å to about 4 Å, about 1 Å to about 5 Å, about 1 Å to about 6 Å, about 1 Å to about 7 Å, about 1 Å to about 8 Å, about 1 Å to about 9 Å, about 1 Å to about 10 Å, about 1 Å to about 20 Å, about 2 Å to about 3 Å, about 2 Å to about 3.5 Å, about 2 Å to about 4 Å, about 2 Å to about 5 Å, about 2 Å to about 6 Å, about 2 Å to about 7 Å, about 2 Å to about 8 Å, about 2 Å to about 9 Å, about 2 Å to about 10 Å, about 2 Å to about 20 Å, about 3 Å to about 3.5 Å, about 3 Å to about 4 Å, about 3 Å to about 5 Å, about 3 Å to about 6 Å, about 3 Å to about 7 Å, about 3 Å to about 8 Å, about 3 Å to about 9 Å, about 3 Å to about 10 Å, about 3 Å to about 20 Å, about 3.5 Å to about 4 Å, about 3.5 Å to about 5 Å, about 3.5 Å to about 6 Å, about 3.5 Å to about 7 Å, about 3.5 Å to about 8 Å, about 3.5 Å to about 9 Å, about 3.5 Å to about 10 Å, about 3.5 Å to about 20 Å, about 4 Å to about 5 Å, about 4 Å to about 6 Å, about 4 Å to about 7 Å, about 4 Å to about 8 Å, about 4 Å to about 9 Å, about 4 Å to about 10 Å, about 4 Å to about 20 Å, about 5 Å to about 6 Å, about 5 Å to about 7 Å, about 5 Å to about 8 Å, about 5 Å to about 9 Å, about 5 Å to about 10 Å, about 5 Å to about 20 Å, about 6 Å to about 7 Å, about 6 Å to about 8 Å, about 6 Å to about 9 Å, about 6 Å to about 10 Å, about 6 Å to about 20 Å, about 7 Å to about 8 Å, about 7 Å to about 9 Å, about 7 Å to about 10 Å, about 7 Å to about 20 Å, about 8 Å to about 9 Å, about 8 Å to about 10 Å, about 8 Å to about 20 Å, about 9 Å to about 10 Å, about 9 Å to about 20 Å, or about 10 Å to about 20 Å. In some cases, the interlayer hydrophobic channels have an average thickness of about 1 Å, about 2 Å, about 3 Å, about 3.5 Å, about 4 Å, about 5 Å, about 6 Å, about 7 Å, about 8 Å, about 9 Å, about 10 Å, or about 20 Å. In some cases, the interlayer hydrophobic channels have an average thickness of less than 20 Å. In some cases, the interlayer hydrophobic channels have an average thickness of less than 5 Å. In some cases, the interlayer hydrophobic channels have an average thickness of about 3.4 Å.

In some cases, the water-permeable membrane has a thickness of at least about 50 μm, about 100 μm, about 150 μm, about 200 μm, about 250 μm, about 300 μm, about 350 μm, about 400 μm, about 450 μm, about 500 μm, about 1,000 μm, or about 2,000 μm. In some cases, the water-permeable membrane has a thickness of at most about 50 μm, about 100 μm, about 150 μm, about 200 μm, about 250 μm, about 300 μm, about 350 μm, about 400 μm, about 450 μm, about 500 μm, about 1,000 μm, or about 2,000 μm. In some cases, the water-permeable membrane has a thickness of about 50 μm to about 2,000 μm. In some cases, the water-permeable membrane has a thickness of about 50 μm to about 100 μm, about 50 μm to about 150 μm, about 50 μm to about 200 μm, about 50 μm to about 250 μm, about 50 μm to about 300 μm, about 50 μm to about 350 μm, about 50 μm to about 400 μm, about 50 μm to about 450 μm, about 50 μm to about 500 μm, about 50 μm to about 1,000 μm, about 50 μm to about 2,000 μm, about 100 μm to about 150 μm, about 100 μm to about 200 μm, about 100 μm to about 250 μm, about 100 μm to about 300 μm, about 100 μm to about 350 μm, about 100 μm to about 400 μm, about 100 μm to about 450 μm, about 100 μm to about 500 μm, about 100 μm to about 1,000 μm, about 100 μm to about 2,000 μm, about 150 μm to about 200 μm, about 150 μm to about 250 μm, about 150 μm to about 300 μm, about 150 μm to about 350 μm, about 150 μm to about 400 μm, about 150 μm to about 450 μm, about 150 μm to about 500 μm, about 150 μm to about 1,000 μm, about 150 μm to about 2,000 μm, about 200 μm to about 250 μm, about 200 μm to about 300 μm, about 200 μm to about 350 μm, about 200 μm to about 400 μm, about 200 μm to about 450 μm, about 200 μm to about 500 μm, about 200 μm to about 1,000 μm, about 200 μm to about 2,000 μm, about 250 μm to about 300 μm, about 250 μm to about 350 μm, about 250 μm to about 400 μm, about 250 μm to about 450 μm, about 250 μm to about 500 μm, about 250 μm to about 1,000 μm, about 250 μm to about 2,000 μm, about 300 μm to about 350 μm, about 300 μm to about 400 μm, about 300 μm to about 450 μm, about 300 μm to about 500 μm, about 300 μm to about 1,000 μm, about 300 μm to about 2,000 μm, about 350 μm to about 400 μm, about 350 μm to about 450 μm, about 350 μm to about 500 μm, about 350 μm to about 1,000 μm, about 350 μm to about 2,000 μm, about 400 μm to about 450 μm, about 400 μm to about 500 μm, about 400 μm to about 1,000 μm, about 400 μm to about 2,000 μm, about 450 μm to about 500 μm, about 450 μm to about 1,000 μm, about 450 μm to about 2,000 μm, about 500 μm to about 1,000 μm, about 500 μm to about 2,000 μm, or about 1,000 μm to about 2,000 μm. In some cases, the water-permeable membrane has a thickness of about 50 μm, about 100 μm, about 150 μm, about 200 μm, about 250 μm, about 300 μm, about 350 μm, about 400 μm, about 450 μm, about 500 μm, about 1,000 μm, or about 2,000 μm. In some cases, the water-permeable membrane has a thickness of less than 1,000 μm. In some cases, the water-permeable membrane has a thickness of between 100 to 500 μm. In some cases, the water-permeable membrane has a thickness of about 250 μm.

In some cases, the water-permeable membrane comprises a synthetic graphene membrane. In some cases, the water-permeable membrane comprises a highly ordered pyrolytic graphite (HOPG) membrane. In some cases, the water-permeable membrane is fixed to the supporting layer. In some cases, the interlayer hydrophobic channels are positioned to be perpendicular to the supporting layer.

In some cases, the supporting layer comprises a membrane with an average pore size of at least about 1 μm, about 2 μm, about 3 μm, about 4 μm, about 5 μm, about 6 μm, about 7 μm, about 8 μm, about 9 μm, about 10 μm, or about 20 μm. In some cases, the average pore size is at most about 1 μm, about 2 μm, about 3 μm, about 4 μm, about 5 μm, about 6 μm, about 7 μm, about 8 μm, about 9 μm, about 10 μm, or about 20 μm. In some cases, the average pore size is about 1 μm to about 20 μm. In some cases, the average pore size is about 1 μm to about 2 μm, about 1 μm to about 3 μm, about 1 μm to about 4 μm, about 1 μm to about 5 μm, about 1 μm to about 6 μm, about 1 μm to about 7 μm, about 1 μm to about 8 μm, about 1 μm to about 9 μm, about 1 μm to about 10 μm, about 1 μm to about 20 μm, about 2 μm to about 3 μm, about 2 μm to about 4 μm, about 2 μm to about 5 μm, about 2 μm to about 6 μm, about 2 μm to about 7 μm, about 2 μm to about 8 μm, about 2 μm to about 9 μm, about 2 μm to about 10 μm, about 2 μm to about 20 μm, about 3 μm to about 4 μm, about 3 μm to about 5 μm, about 3 μm to about 6 μm, about 3 μm to about 7 μm, about 3 μm to about 8 μm, about 3 μm to about 9 μm, about 3 μm to about 10 μm, about 3 μm to about 20 μm, about 4 μm to about 5 μm, about 4 μm to about 6 μm, about 4 μm to about 7 μm, about 4 μm to about 8 μm, about 4 μm to about 9 μm, about 4 μm to about 10 μm, about 4 μm to about 20 μm, about 5 μm to about 6 μm, about 5 μm to about 7 μm, about 5 μm to about 8 μm, about 5 μm to about 9 μm, about 5 μm to about 10 μm, about 5 μm to about 20 μm, about 6 μm to about 7 μm, about 6 μm to about 8 μm, about 6 μm to about 9 μm, about 6 μm to about 10 μm, about 6 μm to about 20 μm, about 7 μm to about 8 μm, about 7 μm to about 9 μm, about 7 μm to about 10 μm, about 7 μm to about 20 μm, about 8 μm to about 9 μm, about 8 μm to about 10 μm, about 8 μm to about 20 μm, about 9 μm to about 10 μm, about 9 μm to about 20 μm, or about 10 μm to about 20 μm. In some cases, the average pore size is about 1 μm, about 2 μm, about 3 μm, about 4 μm, about 5 μm, about 6 μm, about 7 μm, about 8 μm, about 9 μm, about 10 μm, or about 20 μm. In some cases, the average pore size is less than 10 μm. In some cases, the average pore size is about 3 μm. In some cases, the supporting layer can be any material that provides structure support for the water-permeable membrane. In some cases, the supporting layer comprises a polytetrafluoroethylene (PTFE) membrane.

In some cases, at least one edge plane of the water-permeable membrane is hydrophilic. In some cases, the at least one edge plane of the water-permeable membrane has a water contact angle of at most about 10°, about 20°, about 30°, about 40°, about 50°, about 60°, about 70°, about 80°, or about 90°. In some cases, the water contact angle is about 10° to about 90°. In some cases, the water contact angle is about 10° to about 20°, about 10° to about 30°, about 10° to about 40°, about 10° to about 50°, about 10° to about 60°, about 10° to about 70°, about 10° to about 80°, about 10° to about 90°, about 20° to about 30°, about 20° to about 40°, about 20° to about 50°, about 20° to about 60°, about 20° to about 70°, about 20° to about 80°, about 20° to about 90°, about 30° to about 40°, about 30° to about 50°, about 30° to about 60°, about 30° to about 70°, about 30° to about 80°, about 30° to about 90°, about 40° to about 50°, about 40° to about 60°, about 40° to about 70°, about 40° to about 80°, about 40° to about 90°, about 50° to about 60°, about 50° to about 70°, about 50° to about 80°, about 50° to about 90°, about 60° to about 70°, about 60° to about 80°, about 60° to about 90°, about 70° to about 80°, about 70° to about 90°, or about 80° to about 90°. In some cases, the water contact angle is about 10°, about 20°, about 30°, about 40°, about 50°, about 60°, about 70°, about 80°, or about 90°. In some cases, the water contact angle is smaller than 90°. In some cases, the water contact angle is smaller than 30°. In some cases, both edge planes of the water-permeable membrane are hydrophilic. In some cases, both edge planes of the water-permeable membrane have a water contact angle of at most about 10°, about 20°, about 30°, about 40°, about 50°, about 60°, about 70°, about 80°, or about 90°. In some cases, both edge planes of the water-permeable membrane have a water contact angle of about 10° to about 90°. In some cases, both edge planes of the water-permeable membrane have a water contact angle of less than 90°. In some cases, both edge planes of the water-permeable membrane have a water contact angle of less than 30°.

In some cases, at least one surface of the interlayer hydrophobic channels is hydrophobic. In some cases, the at least one surface of the interlayer hydrophobic channels has a water contact angle of at most about 90°, about 100°, about 110°, about 120°, about 130°, about 140°, about 150°, about 160°, about 170°, or about 180°. In some cases, the water contact angle is about 90° to about 180°. In some cases, the water contact angle is about 90° to about 100°, about 90° to about 110°, about 90° to about 120°, about 90° to about 130°, about 90° to about 140°, about 90° to about 150°, about 90° to about 160°, about 90° to about 170°, about 90° to about 180°, about 100° to about 110°, about 100° to about 120°, about 100° to about 130°, about 100° to about 140°, about 100° to about 150°, about 100° to about 160°, about 100° to about 170°, about 100° to about 180°, about 110° to about 120°, about 110° to about 130°, about 110° to about 140°, about 110° to about 150°, about 110° to about 160°, about 110° to about 170°, about 110° to about 180°, about 120° to about 130°, about 120° to about 140°, about 120° to about 150°, about 120° to about 160°, about 120° to about 170°, about 120° to about 180°, about 130° to about 140°, about 130° to about 150°, about 130° to about 160°, about 130° to about 170°, about 130° to about 180°, about 140° to about 150°, about 140° to about 160°, about 140° to about 170°, about 140° to about 180°, about 150° to about 160°, about 150° to about 170°, about 150° to about 180°, about 160° to about 170°, about 160° to about 180°, or about 170° to about 180°. In some cases, the water contact angle is about 90°, about 100°, about 110°, about 120°, about 130°, about 140°, about 150°, about 160°, about 170°, or about 180°.

In some cases, the water-permeable device has a low ion permeation rate when applying an ion solution of 1 M (e.g., K⁺, Na⁺, Cl⁻, Mg²⁺ or [Fe(CN)₆]³⁻). For example, the ion permeation rate is about 0.001 mol per h per m\hat{ }2 to about 1 mol per h per m\hat{ }2. In some cases, the ion permeation rate is at least about 0.001 mol per h per m\hat{ }2, about 0.005 mol per h per m\hat{ }2, about 0.01 mol per h per m\hat{ }2, about 0.05 mol per h per m\hat{ }2, about 0.1 mol per h per m\hat{ }2, about 0.5 mol per h per m\hat{ }2, or about 1 mol per h per m\hat{ }2. In some cases, the ion permeation rate is at most about 0.001 mol per h per m\hat{ }2, about 0.005 mol per h per m\hat{ }2, about 0.01 mol per h per m\hat{ }2, about 0.05 mol per h per m\hat{ }2, about 0.1 mol per h per m\hat{ }2, about 0.5 mol per h per m\hat{ }2, or about 1 mol per h per m\hat{ }2. In some cases, the ion permeation rate is about 0.001 mol per h per m\hat{ }2 to about 0.005 mol per h per m\hat{ }2, about 0.001 mol per h per m\hat{ }2 to about 0.01 mol per h per m\hat{ }2, about 0.001 mol per h per m\hat{ }2 to about 0.05 mol per h per m\hat{ }2, about 0.001 mol per h per m\hat{ }2 to about 0.1 mol per h per m\hat{ }2, about 0.001 mol per h per m\hat{ }2 to about 0.5 mol per h per m\hat{ }2, about 0.001 mol per h per m\hat{ }2 to about 1 mol per h per m\hat{ }2, about 0.005 mol per h per m\hat{ }2 to about 0.01 mol per h per m\hat{ }2, about 0.005 mol per h per m\hat{ }2 to about 0.05 mol per h per m\hat{ }2, about 0.005 mol per h per m\hat{ }2 to about 0.1 mol per h per m\hat{ }2, about 0.005 mol per h per m\hat{ }2 to about 0.5 mol per h per m\hat{ }2, about 0.005 mol per h per m\hat{ }2 to about 1 mol per h per m\hat{ }2, about 0.01 mol per h per m\hat{ }2 to about 0.05 mol per h per m\hat{ }2, about 0.01 mol per h per m\hat{ }2 to about 0.1 mol per h per m\hat{ }2, about 0.01 mol per h per m\hat{ }2 to about 0.5 mol per h per m\hat{ }2, about 0.01 mol per h per m\hat{ }2 to about 1 mol per h per m\hat{ }2, about 0.05 mol per h per m\hat{ }2 to about 0.1 mol per h per m\hat{ }2, about 0.05 mol per h per m\hat{ }2 to about 0.5 mol per h per m\hat{ }2, about 0.05 mol per h per m\hat{ }2 to about 1 mol per h per m\hat{ }2, about 0.1 mol per h per m\hat{ }2 to about 0.5 mol per h per m\hat{ }2, about 0.1 mol per h per m\hat{ }2 to about 1 mol per h per m\hat{ }2, or about 0.5 mol per h per m\hat{ }2 to about 1 mol per h per m\hat{ }2. In some cases, the ion permeation rate is about 0.001 mol per h per m\hat{ }2, about 0.005 mol per h per m\hat{ }2, about 0.01 mol per h per m\hat{ }2, about 0.05 mol per h per m\hat{ }2, about 0.1 mol per h per m\hat{ }2, about 0.5 mol per h per m\hat{ }2, or about 1 mol per h per m\hat{ }2. In some cases, the ion permeation rate is less than 0.001 mol·h⁻¹·m⁻². In some cases, the ion comprises K⁺, Na⁺, Cl⁻, Mg²⁺ or [Fe(CN)₆]³⁻.

In some cases, the water-permeable device has an ion rejection rate of about 50% to about 99%. In some cases, the ion rejection rate is at least about 50%, about 60%, about 70%, about 80%, about 90%, about 95%, or about 99%. In some cases, the ion rejection rate is at most about 50%, about 60%, about 70%, about 80%, about 90%, about 95%, or about 99%. In some cases, the ion rejection rate is about 50% to about 60%, about 50% to about 70%, about 50% to about 80%, about 50% to about 90%, about 50% to about 95%, about 50% to about 99%, about 60% to about 70%, about 60% to about 80%, about 60% to about 90%, about 60% to about 95%, about 60% to about 99%, about 70% to about 80%, about 70% to about 90%, about 70% to about 95%, about 70% to about 99%, about 80% to about 90%, about 80% to about 95%, about 80% to about 99%, about 90% to about 95%, about 90% to about 99%, or about 95% to about 99%. In some cases, the ion rejection rate is about 50%, about 60%, about 70%, about 80%, about 90%, about 95%, or about 99%. In some cases, the water-permeable device has an ion rejection rate of more than 80%. In some cases, the water-permeable device has an ion rejection rate of more than 95%. In some cases, the ion comprises K⁺, Na⁺, Cl⁻, Mg²⁺ or [Fe(CN)₆]³⁻. In some cases, the water-permeable device has Na⁺ rejection rate of more than about 90%. In some cases, the water-permeable device has Na⁺ rejection rate of more than about 95%. In some cases, the water-permeable device has Na⁺ rejection rate of about 90% to 99%. In some cases, the water-permeable device has Na⁺ rejection rate of about 98%.

In some cases, the water-permeable device has a water permeability of about 20 LMH bar to about 200 LMH bar. In some cases, the water permeability is at least about 20 LMH bar, about 30 LMH bar, about 40 LMH bar, about 50 LMH bar, about 60 LMH bar, about 70 LMH bar, about 80 LMH bar, about 90 LMH bar, about 100 LMH bar, about 150 LMH bar, or about 200 LMH bar. In some cases, the water permeability is at most about 20 LMH bar, about 30 LMH bar, about 40 LMH bar, about 50 LMH bar, about 60 LMH bar, about 70 LMH bar, about 80 LMH bar, about 90 LMH bar, about 100 LMH bar, about 150 LMH bar, or about 200 LMH bar. In some cases, the water permeability is about 20 LMH bar to about 30 LMH bar, about 20 LMH bar to about 40 LMH bar, about 20 LMH bar to about 50 LMH bar, about 20 LMH bar to about 60 LMH bar, about 20 LMH bar to about 70 LMH bar, about 20 LMH bar to about 80 LMH bar, about 20 LMH bar to about 90 LMH bar, about 20 LMH bar to about 100 LMH bar, about 20 LMH bar to about 150 LMH bar, about 20 LMH bar to about 200 LMH bar, about 30 LMH bar to about 40 LMH bar, about 30 LMH bar to about 50 LMH bar, about 30 LMH bar to about 60 LMH bar, about 30 LMH bar to about 70 LMH bar, about 30 LMH bar to about 80 LMH bar, about 30 LMH bar to about 90 LMH bar, about 30 LMH bar to about 100 LMH bar, about 30 LMH bar to about 150 LMH bar, about 30 LMH bar to about 200 LMH bar, about 40 LMH bar to about 50 LMH bar, about 40 LMH bar to about 60 LMH bar, about 40 LMH bar to about 70 LMH bar, about 40 LMH bar to about 80 LMH bar, about 40 LMH bar to about 90 LMH bar, about 40 LMH bar to about 100 LMH bar, about 40 LMH bar to about 150 LMH bar, about 40 LMH bar to about 200 LMH bar, about 50 LMH bar to about 60 LMH bar, about 50 LMH bar to about 70 LMH bar, about 50 LMH bar to about 80 LMH bar, about 50 LMH bar to about 90 LMH bar, about 50 LMH bar to about 100 LMH bar, about 50 LMH bar to about 150 LMH bar, about 50 LMH bar to about 200 LMH bar, about 60 LMH bar to about 70 LMH bar, about 60 LMH bar to about 80 LMH bar, about 60 LMH bar to about 90 LMH bar, about 60 LMH bar to about 100 LMH bar, about 60 LMH bar to about 150 LMH bar, about 60 LMH bar to about 200 LMH bar, about 70 LMH bar to about 80 LMH bar, about 70 LMH bar to about 90 LMH bar, about 70 LMH bar to about 100 LMH bar, about 70 LMH bar to about 150 LMH bar, about 70 LMH bar to about 200 LMH bar, about 80 LMH bar to about 90 LMH bar, about 80 LMH bar to about 100 LMH bar, about 80 LMH bar to about 150 LMH bar, about 80 LMH bar to about 200 LMH bar, about 90 LMH bar to about 100 LMH bar, about 90 LMH bar to about 150 LMH bar, about 90 LMH bar to about 200 LMH bar, about 100 LMH bar to about 150 LMH bar, about 100 LMH bar to about 200 LMH bar, or about 150 LMH bar to about 200 LMH bar. In some cases, the water permeability is about 20 LMH bar, about 30 LMH bar, about 40 LMH bar, about 50 LMH bar, about 60 LMH bar, about 70 LMH bar, about 80 LMH bar, about 90 LMH bar, about 100 LMH bar, about 150 LMH bar, or about 200 LMH bar. In some cases, the water-permeable device has a water permeability of more than about 50 LMH bar. In some cases, the water-permeable device has a water permeability of more than about 90 LMH bar.

In some cases, the water-permeable device has a water permeability/pore size (e.g., average thickness of the interlayer hydrophobic channels) of about 1,000 LMH/nm to about 10,000 LMH/nm. In some cases, the water permeability/pore size is at least about 1,000 LMH/nm. In some cases, the water permeability/pore size is at most about 10,000 LMH/nm. In some cases, the water permeability/pore size is about 1,000 LMH/nm to about 1,500 LMH/nm, about 1,000 LMH/nm to about 2,000 LMH/nm, about 1,000 LMH/nm to about 2,500 LMH/nm, about 1,000 LMH/nm to about 3,000 LMH/nm, about 1,000 LMH/nm to about 3,500 LMH/nm, about 1,000 LMH/nm to about 4,000 LMH/nm, about 1,000 LMH/nm to about 4,500 LMH/nm, about 1,000 LMH/nm to about 5,000 LMH/nm, about 1,000 LMH/nm to about 8,000 LMH/nm, about 1,000 LMH/nm to about 10,000 LMH/nm, about 1,500 LMH/nm to about 2,000 LMH/nm, about 1,500 LMH/nm to about 2,500 LMH/nm, about 1,500 LMH/nm to about 3,000 LMH/nm, about 1,500 LMH/nm to about 3,500 LMH/nm, about 1,500 LMH/nm to about 4,000 LMH/nm, about 1,500 LMH/nm to about 4,500 LMH/nm, about 1,500 LMH/nm to about 5,000 LMH/nm, about 1,500 LMH/nm to about 8,000 LMH/nm, about 1,500 LMH/nm to about 10,000 LMH/nm, about 2,000 LMH/nm to about 2,500 LMH/nm, about 2,000 LMH/nm to about 3,000 LMH/nm, about 2,000 LMH/nm to about 3,500 LMH/nm, about 2,000 LMH/nm to about 4,000 LMH/nm, about 2,000 LMH/nm to about 4,500 LMH/nm, about 2,000 LMH/nm to about 5,000 LMH/nm, about 2,000 LMH/nm to about 8,000 LMH/nm, about 2,000 LMH/nm to about 10,000 LMH/nm, about 2,500 LMH/nm to about 3,000 LMH/nm, about 2,500 LMH/nm to about 3,500 LMH/nm, about 2,500 LMH/nm to about 4,000 LMH/nm, about 2,500 LMH/nm to about 4,500 LMH/nm, about 2,500 LMH/nm to about 5,000 LMH/nm, about 2,500 LMH/nm to about 8,000 LMH/nm, about 2,500 LMH/nm to about 10,000 LMH/nm, about 3,000 LMH/nm to about 3,500 LMH/nm, about 3,000 LMH/nm to about 4,000 LMH/nm, about 3,000 LMH/nm to about 4,500 LMH/nm, about 3,000 LMH/nm to about 5,000 LMH/nm, about 3,000 LMH/nm to about 8,000 LMH/nm, about 3,000 LMH/nm to about 10,000 LMH/nm, about 3,500 LMH/nm to about 4,000 LMH/nm, about 3,500 LMH/nm to about 4,500 LMH/nm, about 3,500 LMH/nm to about 5,000 LMH/nm, about 3,500 LMH/nm to about 8,000 LMH/nm, about 3,500 LMH/nm to about 10,000 LMH/nm, about 4,000 LMH/nm to about 4,500 LMH/nm, about 4,000 LMH/nm to about 5,000 LMH/nm, about 4,000 LMH/nm to about 8,000 LMH/nm, about 4,000 LMH/nm to about 10,000 LMH/nm, about 4,500 LMH/nm to about 5,000 LMH/nm, about 4,500 LMH/nm to about 8,000 LMH/nm, about 4,500 LMH/nm to about 10,000 LMH/nm, about 5,000 LMH/nm to about 8,000 LMH/nm, about 5,000 LMH/nm to about 10,000 LMH/nm, or about 8,000 LMH/nm to about 10,000 LMH/nm. In some cases, the water permeability/pore size is about 1,000 LMH/nm, about 1,500 LMH/nm, about 2,000 LMH/nm, about 2,500 LMH/nm, about 3,000 LMH/nm, about 3,500 LMH/nm, about 4,000 LMH/nm, about 4,500 LMH/nm, about 5,000 LMH/nm, about 8,000 LMH/nm, or about 10,000 LMH/nm. In some cases, the water-permeable device has a water permeability/pore size of more than about 2,000 LMH/nm. In some cases, the water permeability/pore size is more than about 4,400 LMH/nm.

In another aspect, disclosed is a method for permeating water, comprising: (a) applying water to a water-permeable device comprising: a supporting layer; and a water-permeable membrane, comprising graphene layers that are aligned to form interlayer hydrophobic channels between the graphene layers, wherein the interlayer hydrophobic channels are positioned to be aligned with the direction of water permeation; and (b) collecting water permeated from the water-permeable device.

In another aspect, disclosed is a method for permeating water, comprising: (a) applying water to the water-permeable device disclosed herein; and (b) collecting water permeated from the water-permeable device.

In another aspect, disclosed is a method for removing ions from water, comprising: (a) applying water to a water-permeable device comprising: a supporting layer; and a water-permeable membrane, comprising graphene layers that are aligned to form interlayer hydrophobic channels between the graphene layers, wherein the interlayer hydrophobic channels are positioned to be aligned with the direction of water permeation; (b) removing ions from the water; and (c) collecting permeated water, wherein the permeated water has a lower ion concentration than the water before being applied to the water-permeable device.

In another aspect, disclosed is a method for removing ions from water, comprising: (a) applying water to the water-permeable device disclosed herein; (b) removing ions from the water; and (c) collecting permeated water, wherein the permeated water has a lower ion concentration than the water before being applied to the water-permeable device.

In another aspect, disclosed is a method for manufacturing a water-permeable device, comprising: fixating a water-permeable membrane on a supporting layer, wherein the water-permeable membrane comprises graphene layers that are aligned to form interlayer hydrophobic channels between the graphene layers, wherein the interlayer hydrophobic channels are positioned to be aligned with the direction of water permeation. In some cases, the method further comprises treating a surface of the water-permeable membrane using reactive-ion etching (RIE).

In another aspect, disclosed is a method for manufacturing the water-permeable device disclosed herein, comprising fixating the water-permeable membrane on the supporting layer. In some cases, the method further comprises treating a surface of the water-permeable membrane using reactive-ion etching (RIE).

It is to be understood that both the foregoing general description and the following detailed description are exemplary, but are not restrictive, of the disclosure.

### BRIEF DESCRIPTION OF THE DRAWING

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A shows an illustration of HOPG membranes with vertically aligned graphene;

FIG. 1B shows optical photographs of a bulky HOPG and HOPG membrane;

FIG. 1C shows a scanning electron microscope (SEM) image of a surface of the HOPG membrane;

FIG. 1D shows an enlarged image of the HOPG membrane surface shown in FIG. 1C;

FIG. 1E shows an enlarged image of the HOPG membrane surface shown in FIG. 1D;

FIG. 2 shows the schematics for HOPG membrane fabrication;

FIG. 3 shows the X-ray diffraction (XRD) of the basal plane and the edge plane (e.g., membrane surfaces) of the HOPG membrane;

FIG. 4 shows SEM images of mechanically cut HOPG slices with 1,000 (left), 500 (middle), and 250 (right) um thicknesses (the planes shown in the figures are basal planes);

FIG. 5 shows the contact angle measurement (A) before and (B) after oxygen RIE treatment on the HOPG membrane surface;

FIG. 6 shows the Raman spectrum of the HOPG membrane surfaces before and after oxygen RIE treatment (with the basal plane, mechanically cut edge plane, and oxygen RIE-treated edge plane shown);

FIGS. 7A-C show X-ray photoelectron spectroscopy (XPS) of the HOPG membrane surfaces and, more specifically, FIG. 7A shows a basal plane; FIG. 7B shows a mechanically cut edge plane; and FIG. 7C shows an oxygen-RIE treated edge plane;

FIG. 8 shows the water permeability of the HOPG membrane before and after oxygen RIE (the HOPG membrane with a 250 μm thickness was tested with N₂ gas at 15 bar);

FIG. 9 shows a schematic of a dead-end membrane filtration system;

FIG. 10 shows the XRD spectrum for the edge planes of the HOPG membrane before and after oxygen RIE treatment;

FIG. 11 shows the flow velocity of the HOPG membrane in comparison to the carbon nanotube (CNT) wall membrane and the open-ended CNT membrane;

FIGS. 12A-B show the terahertz spectroscopy of the intercalated water inside the HOPG membrane and, more specifically, FIG. 12A shows the terahertz time-domain output pulses of the HOPG membrane with and without water and FIG. 12B shows the refractive index of the absorbed water inside the HOPG membrane;

FIG. 13 shows the ion permeation rate of the HOPG membrane;

FIG. 14 shows the NaCl rejection-permeability plot comparing the performance of the HOPG membrane with several types of membranes reported by other researchers (note that the tested concentration of NaCl in these data is different);

FIG. 15 shows the slip length obtained for the HOPG membrane as compared to the slip lengths of vertically aligned (VA) CNT membranes reported by other researchers; and

FIG. 16 shows the permeability normalized to pore size, comparing the permeability normalized to pore size of the HOPG membrane with several types of membranes reported by other researchers.

### DETAILED DESCRIPTION OF THE INVENTION

### Overview

Disclosed are devices and systems for water treatment. For example, devices and systems can comprise a membrane for water treatment. For example, the membrane can be a highly oriented pyrolytic graphite (HOPG) membrane. In other cases, the membrane can be a synthetic graphene membrane. These membranes can act as a high flux reverse osmosis (RO) membrane system. Water can flow through the pores of the membranes or interstices between layers of graphene (e.g., formed by vertically aligned graphenes in HOPG membranes). The surfaces of the membranes can be treated and/or optimized to have a hydrophilic membrane surface and a hydrophobic membrane channel, and/or to act as high flux RO membranes. In some cases, the membranes can be treated by reactive ion etching (RIE), such as oxygen RIE. The treated membranes can produce a purified water that is higher than any reported for commercial RO membranes by more than an order of magnitude, reaching a water flux of 100 LMH·bar. The membranes can also have pores and/or graphene that is well defined and ordered, and can be used as materials for separation and templates at the atomic scale.

The membranes can have a layered structure that comprises stacked graphene layers. In some cases, the membranes can have an average angular spread of less than 10° between the graphene layers, for example, less than 10°, 9°, 8°, 7°, 6°, 5°, 4°, 3°, 2°, 1°, or 0.5° between the graphene layers. In some cases, the membranes can have an average angular spread of from 10° to 0.1° between the graphene layers, for example, from 10° to 5°, from 5° to 3°, from 4° to 2°, from 3° to 1°, from 2° to 0.5°, or from 1.5° to 0.1° between the graphene layers.

In some cases, the membranes can have an average interlayer spacing of less than 20 Å between the structure materials, for example, less than 18 Å, 16 Å, 14 Å, 12 Å, 10 Å, 8 Å, 6 Å, 4 Å, 2 Å, or 1 Å between the structure materials. The membranes can be a high purity carbon material and/or have a highly flat surface.

### Calculation of Permeation Rate

The ion permeation rates, J, can be calculated as:

$$J - D \times Δ C \times \frac{{A}_{eff}}{{L}_{eff}}$$

wherein D is the diffusion coefficient for small ions in water, at about 10⁻⁵ cm²/s. AC is the concentration gradient across the membrane. ΔC is 23 g/L in the case of a 1 M solution of Na⁺. A_{eff} is the effective area of the water column through the membranes (e.g., the effective pore area of the membranes) and L_{eff} is the effective length of the water column (e.g., the penetration length of ions through the membranes). A_{eff} and L_{eff} can be expressed as:

$${A}_{eff} = A \times \frac{d}{L}$$

$${L}_{eff} = L \times \frac{h}{d}$$

wherein A, L, h, and d are the membrane area, the size of graphene sheets consisting of HOPG, the thickness of the membrane, and the interlayer spacing, respectively. Here, A is 4.45 cm², L is 1 μm, h is 250 μm, and d is 3.4 Å.

### Calculation of Slip Length

The slip length can be calculated with an indirect method using the following equation:

$$\frac{V ( λ )}{{V}_{NS}} = ( 1 + \frac{6 λ}{h} )$$

where V(λ) and V_{NS} are the flow velocity with slip and no-slip boundary conditions, respectively; λ is the slip length; and h is the distance between the two sheets (e.g., interlayer spacing). V(λ) can be estimated from the experimentally observed flow velocity when choosing the slip length. The size of the interlayer space can be determined by XRD measurement for the interlayer spacing, h. V_{NS} can be calculated using the Poiseuille flow between two stationary plates with no slip [V_{NS}=(h2Δp)/(12 μL) from the Stokes equation]. Poiseuille flow V(λ) between two stationary plates with slip boundary condition can be expressed as:

$$V ( λ ) = \frac{{h}^{2}}{12 μ} ( - \frac{dp}{dx} ) ( 1 + \frac{6 λ}{h} )$$

wherein Δp/dx, μ, and L are pressure drop, viscosity, and channel length, respectively.

### EXAMPLES

The following examples are included to more clearly demonstrate the overall nature of the disclosure. These examples are exemplary, not restrictive, of the disclosure.

### Example 1 Fabrication of the HOPG Membrane

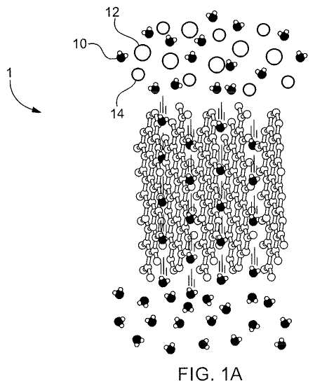

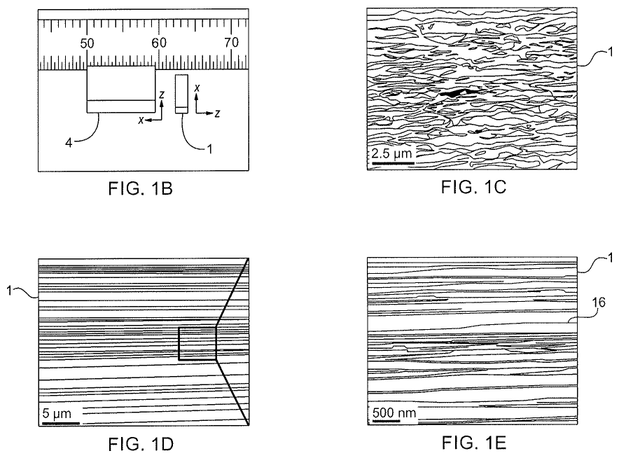

FIG. 1A illustrates a HOPG membrane 1 with vertically aligned graphene 16. FIG. 1A also shows water molecules 10 in the HOPG membrane 1 as well as sodium (Na) ions 12 and chlorine (Cl) ions 14. FIG. 1B shows optical photographs of a bulky HOPG 4 and the HOPG membrane 1, with the direction of the z-axis out of the basal plane of the graphene 16 or the stacking direction of the graphene 16. FIGS. 1C-E show scanning electron microscope (SEM) images of a surface of the HOPG membrane 1. The vertical alignment of the graphene 16 and the graphene layered structure was obviously observed from FIG. 1D (an enlarged image of the HOPG membrane surface shown in FIG. 1C) and FIG. 1E (an enlarged image of the HOPG membrane surface shown in FIG. 1D). The surfaces shown in the SEM images are inclined planes.

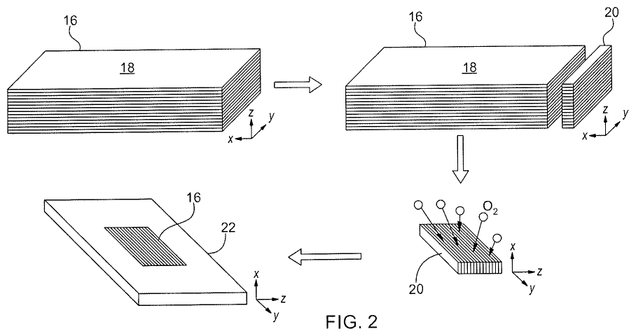

FIG. 2 shows the schematics for fabrication of the HOPG membrane 1. Step 1 begins with an HOPG plate obtained from Alfa Aesar (Product No. 43835) having the dimensions 10×10×1.6 mm. In FIG. 2, the direction of the z-axis is the direction perpendicular to the basal plane 18 of the graphene 16 or the staking direction of the graphene 16. The direction of the x-axis is the parallel direction to the basal plane 18 or the direction to which the graphene 16 is vertically aligned (e.g., at intervals of 3.4 Å), which can also be the permeation direction of the water molecules 10. Accordingly, the top and bottom surfaces of the HOPG membrane 1 (e.g., the y and z plane or the cutting plane of the HOPG) were the edge planes 20.

As illustrated in FIG. 2, in Step 2 of the fabrication process the HOPG plate is mechanically cut using a milling machine equipped with a cemented carbide blade to the size of 1,000, 500, and 250 μm to create the edge planes 20. The width of the HOPG plate being cut became the thickness of the HOPG membrane 1, which then became the permeation length of the water molecules 10 in the HOPG membrane 1. In Step 3 of the fabrication process, both of the edge planes 20 of the HOPG plate are plasma-treated using an RIE etcher to make the edge planes 20 hydrophilic. Finally, in Step 4 of the fabrication process, the graphene 16 is surrounded with an epoxy 22. More specifically, the HOPG slice was positioned on a commercial PTFE membrane (a Millipore Fluorepore™ membrane filter with an average pore size of 3 μm) treated with ethanol. The PTFE membrane functions as a support layer for the HOPG slice. The HOPG slice on the PTFE membrane was surrounded by the high-viscous epoxy 22 to clamp the HOPG slice under high test pressure. The HOPG slice surrounded by the epoxy 22 was then cured at room temperature for 24 hours. The resultant membrane is the HOPG membrane 1 used in the experiments conducted.

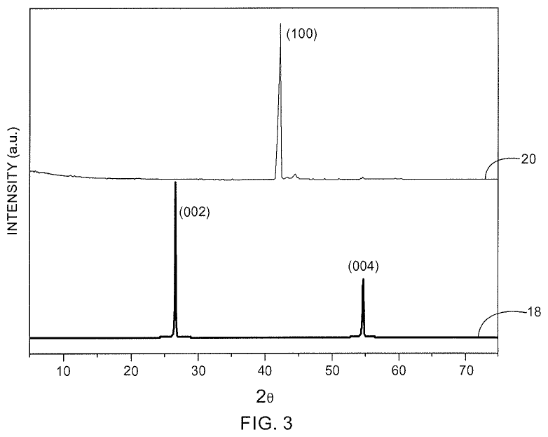

The orientation of graphene 16 in the HOPG membrane 1 was observed with X-ray diffraction (XRD). See FIG. 3. The XRD analysis was performed on a Bruker D8-advance X-ray diffractometer equipped with Ge-monochromatized Cu Kα radiation (λ=1.5418 Å).

The XRD pattern on the basal plane 18 of the HOPG showed a typical graphite pattern. A peak at 20=24.6° signified the (002) crystal plane, which means the basal plane 18 of graphene, and the interlayer spacing between graphenes was 3.4 Å. The (002) plane at 24.6° and the (004) plane at 54.7° were parallel. A peak at 42.3° was observed in the pattern on the edge plane 20 (cutting plane) of the HOPG which signifies the (100) crystal plane. The (001) peak signified that the graphene was vertically aligned because the (100) plane was perpendicular to the (002) plane. Therefore, the mechanically cut HOPG was vertically aligned graphene membrane when the edge plane 20 (cutting plane) of the HOPG was used as a membrane surface for water permeation.

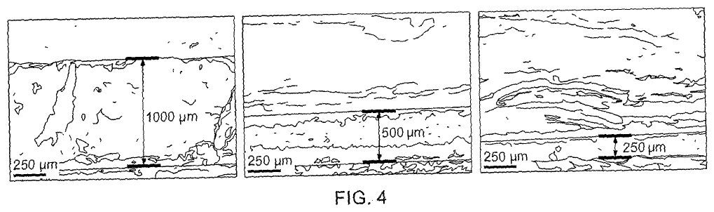

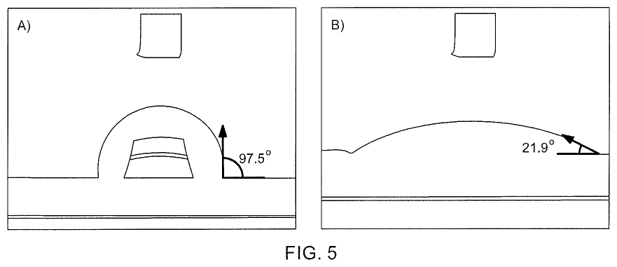

FIG. 4 shows SEM images of mechanically cut HOPG slices with 1,000 (left), 500 (middle), and 250 (right) μm thicknesses (the planes shown in the figures are basal planes). The SEM images were taken with a Carl Zeiss SUPRA 55VP FE-SEM at an acceleration voltage of 15 kV.

### Example 2 Treatment of the HOPG Membrane

The top and bottom edge planes 20 of the HOPG slices were plasma-treated by an RIE etcher with oxygen (e.g., plasma finish, V15-G) to make the edge planes 20 hydrophilic. The RIE etcher was equipped with microwave power, set at about 300 W. The work pressure was set at about 0.1 Torr in the chamber. During the RIE process, the flow rate of oxygen was set at 300 standard cubic centimeter per minute (sccm) for an etch time of 120 s.

The modification can make water molecules 10 easily permeate through the surface of the HOPG membrane 1. An oxygen plasma treatment in the form of oxygen reactive ion etching (RIE) was carried out on both surfaces of the HOPG membrane 1.

The transformation of both the top and bottom surfaces of the HOPG membrane 1 to hydrophilic surfaces after oxygen RIE treatment was observed by contact angle measurement. See FIG. 5. The contact angle of the surfaces of the HOPG membrane 1 was measured with a KRÜSS DSA 100 instrument. The surfaces before the treatment, only mechanically cut surfaces without other treatments, were hydrophobic (contact angle of 97.5°) as shown in the left-hand portion (A) of FIG. 5. After the treatment, as shown in the right-hand portion (B) of FIG. 5, the surfaces became hydrophilic (contact angle of 21.9°).

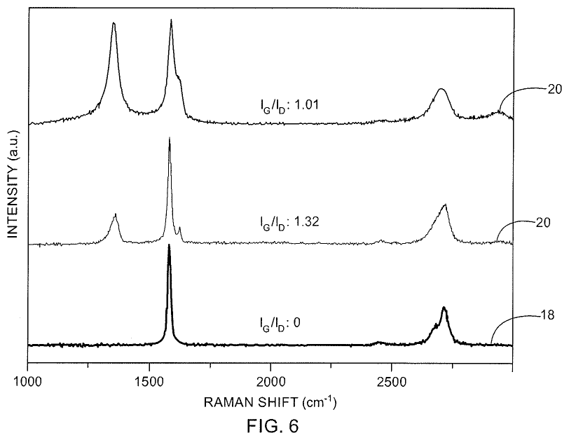

The formation of hydrophilic functional groups on the surface was confirmed by Raman spectroscopy. See FIG. 6. Raman spectra were obtained on a confocal laser micro Raman spectrometer with a 532 nm laser source (LabRam 300, JY-Horiba) and ×100 objective lens. The Raman spectrum (bottom curve) of the basal plane 18 of the HOPG exhibited only a G peak and a 2D peak, which indicated that the plane was a perfect graphene surface without defects while D peaks of the edge plane 20 of the HOPG were the result of defects on the edge of the graphene 16. The peak intensity ratio of the D-to-G band (I_{G}/I_{D}) of the mechanically cut but un-treated edge plane 20 (middle curve) was relatively high at about 1.3. The increase in peak intensity indicated the formation of oxygen functional groups. The ratio of the RIE-treated edge plane 20 (top curve) was about 1.

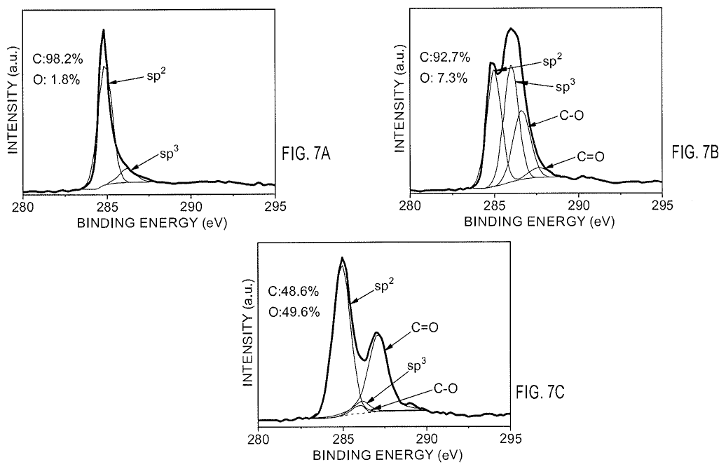

The formation of hydrophilic functional groups on the surface was also confirmed by X-ray photoelectron spectroscopy (XPS) by deconvolution of the C 1 s spectrum (PHI 5000 versaProbe II; Al Kα source). FIG. 7A shows the basal plane 18; FIG. 7B shows the mechanically cut edge plane 20; and FIG. 7C shows the oxygen-RIE treated edge plane 20. The two peaks at 284, 245 eV were attributed to the sp² and sp³ components. The two peaks were observed in the basal and mechanically cut edge planes of the HOPG. The sp³ peak mainly reflects defects in the carbon nanomaterials. The peak results from defects concentrated in the edge of the graphene making up the HOPG. Oxygen-related functional groups, reflected by an additional two peaks at about 286, 288 eV, were observed along with the two main peaks in the edge plane 20. After oxygen RIE treatment on the edge plane 20, the oxygen content on the edge plane 20 increased. Therefore, the oxygen-related functional groups were increased after the oxygen RIE treatment.

The mechanically cut HOPG slice was positioned on a PTFE membrane with an average pore size of about 3 μm, which was treated with ethanol. The HOPG slice on the PTFE membrane was surrounded by the high-viscous epoxy 22 to clamp the HOPG slice under high test pressure. The HOPG slice surrounded by the epoxy 22 was then cured at room temperature for 24 hours. The resultant membrane is the HOPG membrane 1.

### Example 3 Permeability of the HOPG Membrane

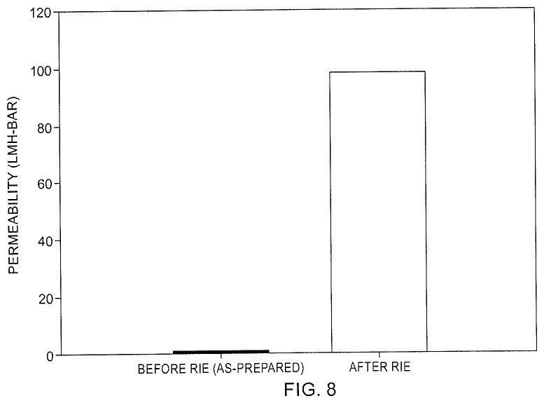

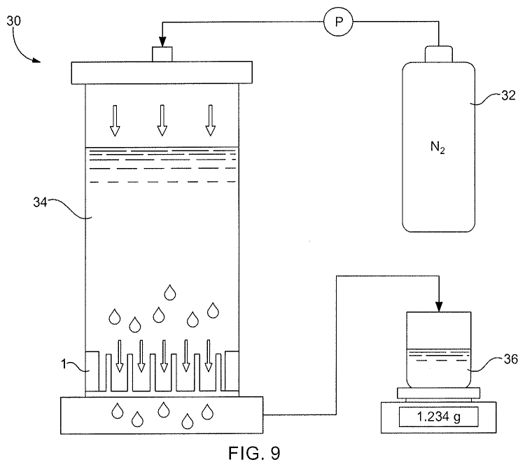

The surface modification of the edge plane 20 of the HOPG membrane 1 can lead to a dramatic increase in permeability. See FIG. 8. The permeability of the RIE-treated HOPG membrane 1 with a 250 μm thickness was 98 LMH·bar when tested with N₂ gas at 15 bar after RIE. The permeability was determined using a dead-end filtration system 30, illustrated schematically in FIG. 9. Water flux and rejection tests were performed in the system 30 with N₂ gas 32 at 15 bar. The feed solution 34 was passed through the HOPG membrane 1. The permeate solution 36 was collected and weighed. Water flux was calculated from the information on permeate volume, test time, and effective membrane area (0.16 cm²).

Ion rejection rate was determined by measuring the conductivity of the permeate solution 36 through the HOPG membrane 1. The conductivity of the feed solution 34 and the permeate solution 36 before and after filtration of ion solutions was measured with a Mettler Toledo SevenCompact™ conductivity meter. The concentration of positive and negative ions in the solution was measured with Shimdzu JP/ICPS-750 (inductively coupled plasma, ICP) and Dionex ICS-3000 (Ion chromatograph, IC), respectively. The NaCl rejection rate was measured to 98%.

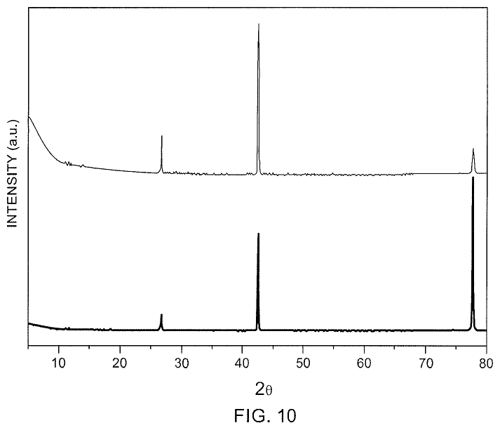

FIG. 10 shows the XRD spectrum for the edge plane 20 of the HOPG membrane 1 before (bottom curve) and after (top curve) oxygen RIE treatment. The interlayer spacing between graphenes (or pore size) maintained at 3.4 Å after RIE on the edge plane 20 of the HOPG. Therefore, the surface modification of the edge plane 20 of the HOPG had no effect on the pore size of the HOPG membrane 1.

The hydrophobic channel wall and the hydrophilic entrance and exit were optimal conditions to realize fast mass transport through the HOPG membrane 1. Water molecules 10 that pass through the entrance can form water chains through hydrogen bonding into the HOPG interior, i.e., graphene channels. The water chains can ballistically pass through the HOPG interior because of frictionless flow between the hydrophobic graphene wall and the water chains. The fast mass transport phenomena result in high permeability. The HOPG membrane 1 realized the phenomena through oxygen RIE treatment.

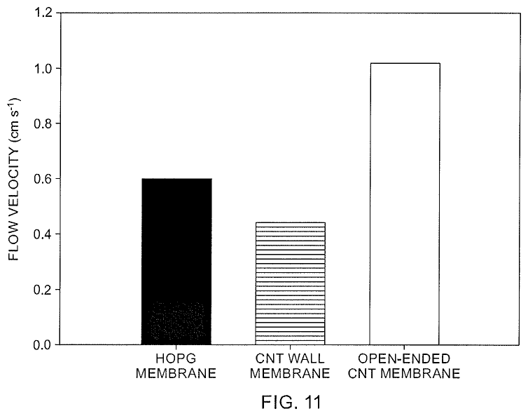

FIG. 11 shows the flow velocity of the HOPG membrane 1 in comparison to the flow velocities reported by other researchers for carbon nanotube (CNT) wall membranes and for open-ended CNT membranes. As illustrated in FIG. 11, the velocity through the HOPG membrane 1 was about as fast as that through the comparison membranes.

The existence of water intercalated into the interlayer spaces was observed with a terahertz wave, defined as an electromagnetic wave within the band of frequencies from 0.3 to 3 terahertz. (THz=1012 Hz). Terahertz waves can penetrate a wide variety of non-conducting materials such as paper, wood, plastic, and ceramic materials but cannot penetrate liquid water or metal. In the case of HOPG, terahertz waves can pass through interlayer spaces because the HOPG has a well-aligned graphene structure in spite of conducting materials.

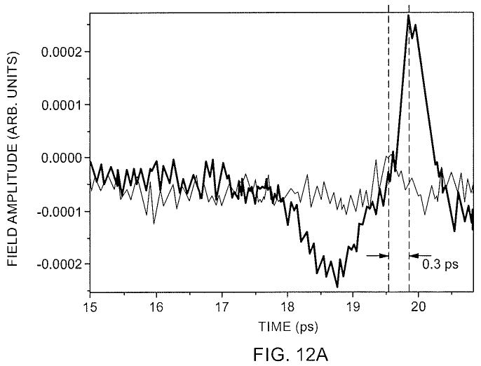

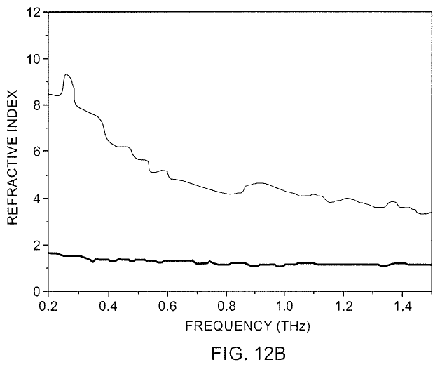

FIGS. 12A and 12B show the terahertz spectroscopy of the intercalated water inside the HOPG membrane 1. FIG. 12A shows the terahertz signal pulse in the time domain on the mechanically cut slices or the HOPG membrane 1 without water (darker curve) and that with water (lighter curve). The edge plane 20 of the HOPG slices was exposed to a terahertz wave. It was measured in the frequency range from 0.1 to 1.5 THz. A sharp THz wave signal through the mechanically cut HOPG slice is shown in FIG. 12A, which indicates that the water molecules 10 were not intercalated into the interlayer space. A THz peak on the HOPG membrane 1 with oxygen RIE treatment can show the significant signal drop and time delay due to the intercalated water molecules 10. It was shown that water molecules 10 were well intercalated into the sub-nanoscale pores of the HOPG membrane 1 after oxygen RIE treatment. The water layer thickness was independently checked by measuring the weight of the HOPG membrane 1 before and after the water permeation test. The weight gain of the HOPG membrane 1 after the permeation test was 12±mg, which corresponded to 0.012 cm³ in bulk volume. The additional weight was due to the intercalated water. The total surface area of the HOPG membrane 1 with a 250 μm thickness was estimated at about 47 m², when considering a theoretical specific surface area of graphene (2,630 m²/g) and mass of the HOPG membrane 1 (18 mg). Given the total surface area, this additional weight was equivalent to a water layer thickness of 0.255 nm, or close to a monolayer thickness of water. It can be concluded that water molecules 10 pass through the HOPG membrane 1 in the form of monolayers and the water molecules 10 were well intercalated into the atomic-scale pores of the HOPG membrane 1.

FIG. 12B presents a refraction index of intercalated water (i.e., of the absorbed water inside the HOPG membrane 1). The top, lighter curve is with water; the bottom, darker curve is without water. The result indicates that the index of the intercalated monolayer water was similar to that of bulk water, as reflected in J. Zhang & D. Grischkowsky, “Terahertz time-domain spectroscopy of submonolayer water adsorption in hydrophilic silica aerogel,” Optics letters 29, 1031-33 (2004).

### Example 4 Comparison of the HOPG Membrane with Other Membranes

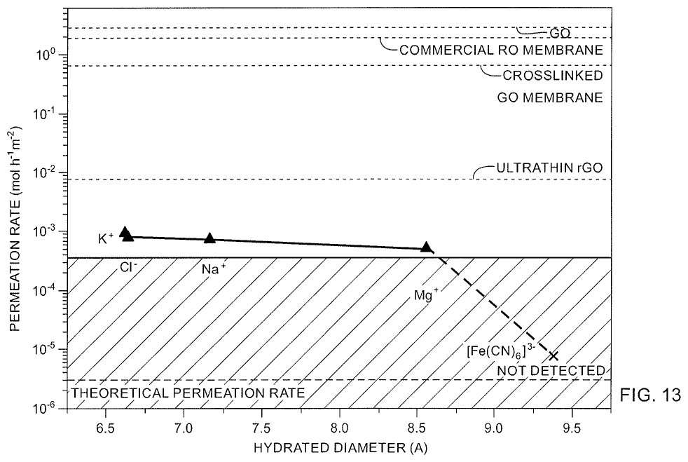

To evaluate the ion sieving ability of the HOPG membrane 1, the ion permeation rate was measured with a hydrostatic pressure driven test cell. The ion concentration of the permeate solution was measured by inductively coupled plasma (ICP) and ion chromatograph (IC) to measure ion concentration into the permeate. The permeation rates observed for five ions (K⁺, Na⁺, Cl⁻, Mg²⁺, and [Fe(CN)₆]³⁻) are shown in FIG. 13. The ion permeation rates of the various ions through the HOPG membrane 1 were observed at a concentration of 1 M. No permeation of [Fe(CN)₆]³⁻ through the HOPG membrane 1 could be detected during measurements lasting for 7 days. The standard deviation of the data obtained in this work is within 30%.

The HOPG membrane 1 showed low permeation rates on small-sized ions such as K⁺, Na⁺, and Cl⁻. The permeation rates approached theoretical limits (cross-hatched area). The permeation rates of K⁺ and Na⁺ ions were lower than an order of 10⁻³. The Cl⁻ amount was measured with NaCl. Cations and anions moved through the HOPG membrane 1 in stoichiometric amounts so that charge neutrality within the permeate was preserved. Cl⁻ was similar to Na⁺ in the permeation rate. The HOPG membrane 1 showed no detectable permeation on large-sized [Fe(CN)₆]³⁻. The theoretical permeation rate of the HOPG membrane 1 was calculated as 3×10⁻⁶ on Na ⁺(lowest dotted line in FIG. 13) which is about two orders of magnitude lower than the measured permeation rate of 7×10⁻⁴. This result was consistent with graphene oxide-based membranes.

The permeation rate of the HOPG membrane 1 for sodium ions was compared with other membranes: graphene oxide (GO)-based membranes (reported in R. Joshi et al., “Precise and ultrafast molecular sieving through graphene oxide membranes,” Science 343, 752-54 (2014)), a commercial RO membrane, crosslinked GO membranes (reported in Z. Jia & Y. Wang, “Covalently crosslinked graphene oxide membranes by esterification reactions for ions separation,” Journal of Materials Chemistry A 3, 4405-12 (2015)), and ultrathin reduced graphene (rGO) membranes (reported in H. Liu, H. Wang, & X. Zhang, “Facile fabrication of freestanding ultrathin reduced graphene oxide membranes for water purification,” Advanced Materials 27, 249-54 (2015)). All publications mentioned in this specification are incorporated by reference to the same extent as if each individual publication were specifically and individually indicated to be incorporated by reference. The permeation rate of the commercial RO membrane (LFC-1) for sodium ions was estimated by the rejection rate measured with the dead-end filtration system 30.

The permeation rates of the GO-based and ultrathin rGO membranes, which was in the form of buckypaper, were measured with osmotic pressure caused by the concentration difference between ion and non-ion solutions without external pressure. The permeation rates of GO-based and ultrathin rGO membranes shown in FIG. 13 were normalized per 1 M ion solution. The test conditions with external pressure were harsher than those with osmotic pressure because high mechanical strength materials was required for the test with external pressure. Nevertheless, the permeation rates of the HOPG membrane 1 on the small sized ions was lower up to about two orders of magnitude than that of the GO-based membranes and one order of magnitude lower than that of ultrathin rGO and was at a similar level to that of commercial membranes measured with external pressure. Swelling of the GO-based membrane can lead to an increase in interlayer spacing (e.g., pore size) into water which enables small-sized ions to pass through the membrane. Ultrathin rGO membranes can be thin in thickness and freestanding and can have many defects because GO is chemically reduced. Small sized ions can pass through defects on rGO sheets, being known to ˜nm in diameter along with interlayer spaces between rGOs. The D peak, signifying defects on graphenes, was not observed in a spectrum on the basal plane 18 as shown in FIG. 6. The interlayer spaces were the only pores in the HOPG membrane 1. Therefore, the low permeation rates resulted from the small pore size of the HOPG membrane 1 which was much smaller than the hydrated diameter of Na⁺ and K⁺.

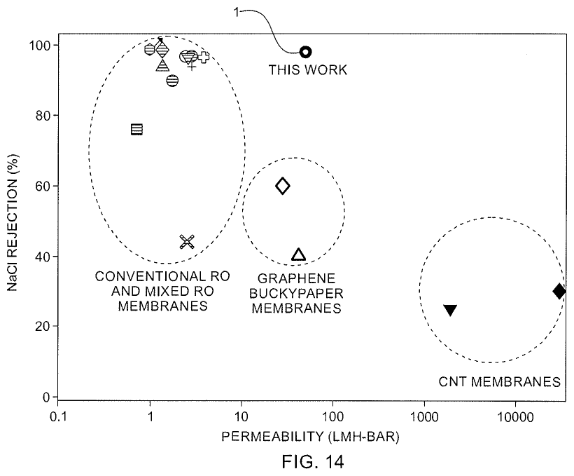

FIG. 14 shows the NaCl rejection-permeability plot comparing the performance of the HOPG membrane 1 (“This Work”) with several types of membranes reported by other researchers (note that the tested concentration of NaCl in these data is different). The data grouped in the oval on the left reflect conventional polymer membranes and CNT- or graphene-mixed thin film composite (TFC) membranes as reported in H. J. Kim et al., “High-performance reverse osmosis CNT/polyamide nanocomposite membrane by controlled interfacial interactions,” ACS applied materials & interfaces 6, 2819-29 (2014), for a conventional polyamide membrane (commercial RO membrane, LFC-1); in H. J. Kim et al., “High-performance reverse osmosis CNT/polyamide nanocomposite membrane by controlled interfacial interactions,” ACS applied materials & interfaces 6, 2819-29 (2014), H. A. Shawky, S.-R. Chae, S. Lin, & M. R. Wiesner, “Synthesis and characterization of a carbon nanotube/polymer nanocomposite membrane for water treatment,” Desalination 272, 46-50 (2011), W.-F. Chan et al., “Zwitterion functionalized carbon nanotube/polyamide nanocomposite membranes for water desalination,”Acs Nano 7, 5308-19 (2013), H. Zhao et al., “Improving the performance of polyamide reverse osmosis membrane by incorporation of modified multi-walled carbon nanotubes,” Journal of Membrane Science 450, 249-56 (2014), and J. nan Shen, C. chao Yu, H. min Ruan, C. jie Gao, & B. Van der Bruggen, “Preparation and characterization of thin-film nanocomposite membranes embedded with poly (methyl methacrylate) hydrophobic modified multiwalled carbon nanotubes by interfacial polymerization,” Journal of Membrane Science 442, 18-26 (2013) for CNT-mixed polyamide TFC membranes; in H. J. Kim, M.-Y. Lim, K. H. Jung, D.-G. Kim, & J.-C. Lee, “High-performance reverse osmosis nanocomposite membranes containing the mixture of carbon nanotubes and graphene oxides,” Journal of Materials Chemistry A 3, 6798-6809 (2015) and H.-R. Chae, J. Lee, C.-H. Lee, I.-C. Kim, & P.-K. Park, “Graphene oxide-embedded thin-film composite reverse osmosis membrane with high flux, anti-biofouling, and chlorine resistance,” Journal of Membrane Science 483, 128-35 (2015) for graphene oxide-mixed TFC membranes; in H. J. Kim, M.-Y. Lim, K. H. Jung, D.-G. Kim, & J.-C. Lee, “High-performance reverse osmosis nanocomposite membranes containing the mixture of carbon nanotubes and graphene oxides,” Journal of Materials Chemistry A 3, 6798-6809 (2015) for CNT-graphene oxide mixed polyamide TFC membranes; and in B.-H. Jeong et al., “Interfacial polymerization of thin film nanocomposites: a new concept for reverse osmosis membranes,” Journal of Membrane Science 294, 1-7 (2007) for a zeolite-mixed polyamide TFC membrane.

The two data points grouped in the middle circle of FIG. 14 reflect graphene buckypaper membranes as reported in Y. Han, Z. Xu & C. Gao, “Ultrathin graphene nanofiltration membrane for water purification,” Advanced Functional Materials 23, 3693-3700 (2013) and M. Hu & B. Mi, “Enabling graphene oxide nanosheets as water separation membranes,” Environmental science & technology 47, 3715-23 (2013). Finally, the two data points grouped in the right circle of FIG. 14 reflect CNT membranes as reported in Y. Baek et al., “High performance and antifouling vertically aligned carbon nanotube membrane for water purification,” Journal of Membrane Science 460, 171-77 (2014) (an open-ended CNT membrane) and B. Lee et al., “A carbon nanotube wall membrane for water treatment,” Nature communications 6, (2015) (a CNT wall membrane).

Conventional RO membranes made of a polyamide active layer showed poor permeability in spite of a high rejection rate to ions. The carbon nanomaterial membranes were shown to have a low ion rejection rate relative to the conventional RO membrane because the pore size is much larger than the size of the ions. The HOPG membrane 1 showed superior properties when compared to conventional RO membranes and carbon nanomaterial membranes.

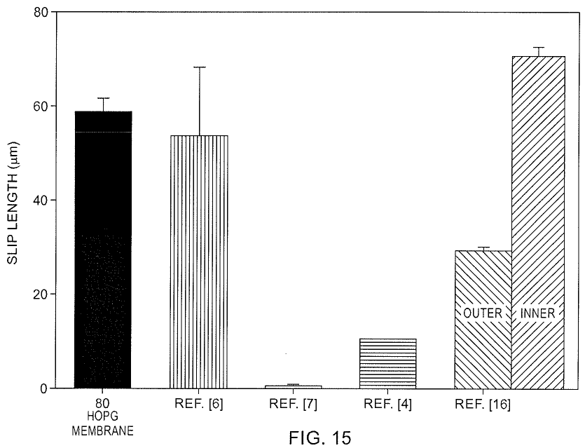

FIG. 15 shows the slip length for the HOPG membrane 1 as compared to the slip lengths reported by other researchers for vertically aligned (VA) CNT membranes. The comparative slip lengths reflect data from M. Majumder, N. Chopra, R. Andrews, & B. Hinds, “Nanoscale hydrodynamics: Enhanced flow in carbon nanotubes,” Nature 438, 44-44 (2005) (Ref [6]) (reported data); J. K. Holt et al., “Fast mass transport through sub-2-nanometer carbon nanotubes,” Science 312, 1034-37 (2006) (Ref [7]) (reported data); F. Du, L. Qu, Z. Xia, L. Feng, & L. Dai, “Membranes of vertically aligned superlong carbon nanotubes,” Langmuir 27, 8437-43 (2011) (Ref [4]) (calculated from the reported data); and J. Walther, K. Ritos, E. Cruz-Chu, C. Megaridis, & P. Koumoutsakos, “Barriers to superfast water transport in carbon nanotube membranes,” Nano Lett 13, 1910-14 (2013) (Ref [16]) (calculated from the reported data). Ref [16] proposed a method to apply carbon nanotubes (CNTs) as a water permeate layer, where the CNTs are vertically aligned so that the water flow is permeated along the vertical direction either inside the tube (“inner”) or outside the tube (“outer”). In the case of “inner,” the CNTs are confined in a polymer matrix and both ends of the CNTs are left open as water permeate channels. In the case of “outer,” the CNTs are free standing and both ends of the CNTs are blocked, so that the water permeates from outside of CNTs.

The slip length of the HOPG membrane 1 was as long as that of the CNT membranes. Hydrophobic CNT walls can lead to a frictionless flow and thus to a high flow velocity as a consequence of the weak interfacial force between water molecules and atomically smooth, hydrophobic CNT inner walls in the case of the open-ended membrane. For the HOPG membrane 1, water molecules 10 can be surrounded by graphene 16; therefore, the same reasoning as for the flow inside of the HOPG membrane 1 would apply, which results in the high slip length.

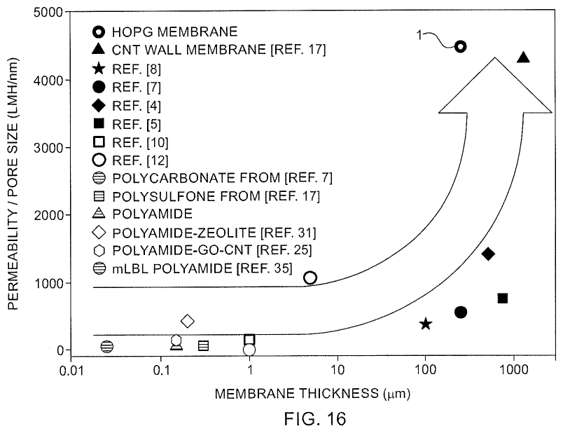

FIG. 16 shows the permeability normalized to pore size, comparing the permeability normalized to pore size of the HOPG membrane 1 with several types of membranes reported by other researchers. The pore sizes among the membranes can be different. The comparative data are from F. Du, L. Qu, Z. Xia, L. Feng, & L. Dai, “Membranes of vertically aligned superlong carbon nanotubes,” Langmuir 27, 8437-43 (2011) (Ref. [4]), M. Yu, H. H. Funke, J. L. Falconer, & R. D. Noble, “High density, vertically-aligned carbon nanotube membranes,” Nano Letters 9, 225-29 (2008) (Ref [5]), J. K. Holt et al., “Fast mass transport through sub-2-nanometer carbon nanotubes,” Science 312, 1034-37 (2006) (Ref [7]), B. J. Hinds et al., “Aligned multiwalled carbon nanotube membranes,” Science 303, 62-65 (2004) (Ref [8]), H. Huang et al., “Ultrafast viscous water flow through nanostrand-channelled graphene oxide membranes,” Nature communications 4, (2013) (Ref [10]), M. Hu & B. Mi, “Enabling graphene oxide nanosheets as water separation membranes,” Environmental science & technology 47, 3715-23 (2013) (Ref [12]), B. Lee et al., “A carbon nanotube wall membrane for water treatment,” Nature communications 6, (2015) (Ref [17]), H. J. Kim, M.-Y. Lim, K. H. Jung, D.-G. Kim, & J.-C. Lee, “High-performance reverse osmosis nanocomposite membranes containing the mixture of carbon nanotubes and graphene oxides,” Journal of Materials Chemistry A 3, 6798-6809 (2015) (Ref [25]), B.-H. Jeong et al., “Interfacial polymerization of thin film nanocomposites: a new concept for reverse osmosis membranes,” Journal of Membrane Science 294, 1-7 (2007) (Ref [31]), and J. E. Gu et al., “Molecular Layer-by-Layer Assembled Thin-Film Composite Membranes for Water Desalination,” Advanced Materials 25, 4778-82 (2013) (Ref [35]).

The average pore size of the conventional polyamide thin-film composite (TFC) membrane is about 4 Å. The normalized permeability of carbon nanomaterial membranes including HOPG, vertically aligned CNT, and graphene membranes is higher than that of conventional membranes, thin film nanocomposite membranes (or mixed membranes) including polyamide zeolite, polyamide-GO-CNT and mLBL (molecular Layer-by-Layer) polyamide although carbon nanomaterial membranes are much thicker than conventional membranes. The HOPG membrane 1 showed very high normalized permeability.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure. It is expressly intended, for example, that all ranges broadly recited in this document include within their scope all narrower ranges which fall within the broader ranges. It is also expressly intended that the steps of the methods of using the various devices disclosed above are not restricted to any particular order.

What is claimed:

1. A water-permeable device having a direction of water permeation and comprising:
a supporting layer; and
a water-permeable membrane including graphene layers that are aligned to form interlayer hydrophobic channels between the graphene layers,
wherein the interlayer hydrophobic channels are positioned to be aligned with the direction of water permeation.

2. The water-permeable device of claim 1, wherein said graphene layers have an average angular spread of less than 10°.

3. The water-permeable device of claim 2, wherein the graphene layers have an average angular spread of less than 1°.

4. The water-permeable device of any one of claims 1-3, wherein the graphene layers have an average size of less than 20 μm.

5. The water-permeable device of claim 4, wherein the graphene layers have an average size of less than 5 μm.

6. The water-permeable device of claim 5, wherein the graphene layers have an average size of about 1 μm.

7. The water-permeable device of any one of claims 1-6, wherein the interlayer hydrophobic channels have an average thickness of less than 20 Å.

8. The water-permeable device of claim 7, wherein the interlayer hydrophobic channels have an average thickness of less than 5 Å.

9. The water-permeable device of claim 8, wherein the interlayer hydrophobic channels have an average thickness of about 3.4 Å.

10. The water-permeable device of any one of claims 1-9, wherein the water-permeable membrane has a thickness of less than 1,000 μm.

11. The water-permeable device of claim 10, wherein the water-permeable membrane has a thickness of between 100 to 500 μm.

12. The water-permeable device of claim 11, wherein the thickness is about 250 μm.

13. The water-permeable device of any one of claims 1-12, wherein the water-permeable membrane includes a synthetic graphene membrane.

14. The water-permeable device of any one of claims 1-13, wherein said water-permeable membrane comprises a HOPG membrane.

15. The water-permeable device of any one of claims 1-14, wherein the water-permeable membrane is fixed to the supporting layer.

16. The water-permeable device of any one of claims 1-15, wherein the interlayer hydrophobic channels are positioned to be perpendicular to the supporting layer.

17. The water-permeable device of any one of claims 1-16, wherein the supporting layer comprises a membrane with an average pore size of less than 10 μm.

18. The water-permeable device of claim 17, wherein the supporting layer comprises a membrane with an average pore size of about 3 μm.

19. The water-permeable device of any one of claims 1-18, wherein the supporting layer comprises a PTFE membrane.

20. The water-permeable device of any one of claims 1-19, wherein the water-permeable membrane has at least one edge plane that is hydrophilic.

21. The water-permeable device of any one of claims 1-20, wherein the at least one edge plane of the water-permeable membrane has a water contact angle of smaller than 90°.

22. The water-permeable device of any one of claims 1-21, wherein the at least one edge plane of the water-permeable membrane has a water contact angle of smaller than 30°.

23. The water-permeable device of any one of claims 1-22, wherein the water-permeable membrane has two hydrophilic edge planes.

24. The water-permeable device of any one of claims 1-23, wherein the edge planes of the water-permeable membrane have a water contact angle of smaller than 90°.

25. The water-permeable device of any one of claims 1-24, wherein the edge planes of the water-permeable membrane have a water contact angle of smaller than 30°.

26. The water-permeable device of any one of claims 1-25, having an ion permeation rate of less than 0.1 mol·h⁻¹·m⁻² when applying an ion solution of 1 M.

27. The water-permeable device of claim 26, wherein the ion permeation rate is less than 0.001 mol·h⁻¹·m⁻².

28. The water-permeable device of any one of claims 1-27, having an ion rejection rate of more than 80%.

29. The water-permeable device of claim 28, wherein the ion rejection rate is more than 95%.

30. The water-permeable device of any one of claims 26-29, wherein the ion comprises K⁺, Na⁺, Cl⁻, Mg²⁺, or [Fe(CN)₆]³⁻.

31. The water-permeable device of claim 30, having a Na⁺ rejection rate of about 98%.

32. The water-permeable device of any one of claims 1-31, having a water permeability of more than 50 LMH·bar.

33. The water-permeable device of claim 32, wherein the water permeability is more than 90 LMH·bar.

34. The water-permeable device of any one of claims 1-33, having a water permeability/pore size of more than 2,000 LMH/nm.

35. The water-permeable device of claim 34, wherein the water permeability/pore size is more than 4,400 LMH/nm.

36. A method for permeating water, comprising:
a) applying water to a water-permeable device including a supporting layer and a water-permeable membrane having graphene layers that are aligned to form interlayer hydrophobic channels between the graphene layers, wherein the interlayer hydrophobic channels are positioned to be aligned with the direction of water permeation; and
b) collecting water permeated from the water-permeable device.

37. A method for permeating water, comprising:
a) applying water to the water-permeable device of any one of claims 1-35; and
b) collecting water permeated from the water-permeable device.

38. A method for removing ions from water, comprising:
a) applying water to a water-permeable device including a supporting layer and a water-permeable membrane having graphene layers that are aligned to form interlayer hydrophobic channels between the graphene layers, wherein the interlayer hydrophobic channels are positioned to be aligned with the direction of water permeation;
b) removing ions from the water; and
c) collecting permeated water, wherein the permeated water has a lower ion concentration than the water before being applied to the water-permeable device.

39. A method for removing ions from water, comprising:
a) applying water to the water-permeable device of any one of claims 1-35;
b) removing ions from the water; and
c) collecting permeated water, wherein the permeated water has a lower ion concentration than the water before being applied to the water-permeable device.

40. A method for manufacturing a water-permeable device, comprising fixating a water-permeable membrane on a supporting layer, wherein the water-permeable membrane includes graphene layers that are aligned to form interlayer hydrophobic channels between the graphene layers, wherein the interlayer hydrophobic channels are positioned to be aligned with the direction of water permeation.

41. A method for manufacturing the water-permeable device in any one of claims 1-35, comprising fixating the water-permeable membrane on the supporting layer.

42. The method of claim 40 or 41, further comprising treating a surface of the water-permeable membrane using reactive-ion etching (RIE).
